(19) United States
(12) Patent Application Publication
(10) Pub. No.: US 2015/0091493 A1
(43) Pub. Date: Apr. 2, 2015

(54) USING PULSE WIDTH MODULATION IN A SINGLE PHASE DRIVE SYSTEM

(71) Applicant: Tribi Systems Private Limited, Company, Bangalore, KA (IN)

(72) Inventors: Jitendra Veer Singh, Bangalore (IN); Sreejakumar Nair, Bangalore (IN)

(21) Appl. No.: 14/382,335

(22) PCT Filed: Mar. 4, 2013
(86) PCT No.: PCT/IN2013/000128

§ 371 Date: Sep. 2, 2014

(30) Foreign Application Priority Data
Mar. 2, 2012 (IN) 809/CHE/2012

(51) Int. Cl. H02P 1/42

(52) U.S. Cl. CPC H02P 1/42
USPC 318/778

(57) ABSTRACT

Embodiments herein disclose a method for enabling operation of a single phase induction motor, the method comprising applying space vector Pulse Width Modulation (PWM) to the single phase induction motor; determining pulse width using location of the space vector associated with space vector PWM; and enhancing voltage levels of the single phase induction motor for a particular DC bus voltage using the determined pulse width and the location of the space vector.

### PRIORITY DETAILS

The present application is a National Phase Application for PCT application No. PCT/1N2013/000128 filed on 4 Mar. 2013, based on and claims priority from IN Applications bearing No. 809/CHE/2012 Filed on 2 Mar. 2012, the disclosure of which is hereby incorporated by reference herein.

### TECHNICAL FIELD

The embodiments herein relate to motors and more particularly, to using pulse width modulation in motor drives.

### BACKGROUND

Pulse width modulation (PWM) or pulse duration modulation (PDM) is a commonly used technique for controlling power to inertial electrical devices, made practical by modern electronic power switches. The average value of voltage (and current) fed to the load is controlled by turning the switch between supply and load on and off at a fast pace. The longer the switch is on compared to the off periods, the higher is the power supplied to the load. The PWM switching frequency has to be much faster than what would affect the load, which is to imply the device that uses the power.

The main advantage of PWM is that power loss in the switching devices is very low. When a switch is OFF, there is practically no current and when it is ON, there is almost no voltage drop across the switch. Power loss, being the product of voltage and current, is thus in both cases close to zero. PWM also works well with digital controls, which, because of their ON/OFF nature, can easily set the needed duty cycle. By varying the duty cycle of the pulse width modulated control signal, the average voltage varies. In this way, a variable voltage may be applied to the motor windings.

Regular 3 phase SVPWM is used to enhance the voltage space-vector in a three phase system. However, it does not help to get the enhancement of voltage in case of two phase PWM. In two phase PWM, the maximum voltage space phasoris limited to Vdc/\sqrt{2}. To supply the designed winding voltage, a very large value of Vdc is required. However, increasing the Vdc results in a rise on costs, stresses on the components within the system resulting in reduced motor life, a reduction in efficiency and an increase in EMI.

In Split cap H-Bridges, the lower switches are operated with sine triangle PWM with modulating wave with 90° phase difference. This gives a maximum phasor of Vdc/2\sqrt{2}. As maximum phasor is proportional to the winding voltage and torque is proportional to the square of applied voltage across the winding, it is important to have designed voltage across the motor winding for the proper operation. To supply the designed winding voltage, a very large value of Vdc is required. However, increasing the Vdc results in a rise on costs, stresses on the components within the system resulting in reduced motor life, a reduction in efficiency and an increase in EMI.

In four leg 2-phase Induction motor drives, a maximum phasor of Vdc can be obtained. However, it requires two extra power devices leading to higher losses. Also, it requires motors with split windings. Normally, available single phase Induction motors have only start, run and common terminals available with the common terminal being the internal joint point of start and run windings. Hence, four legged topologies cannot be used with normally available single phase induction motors.

### SUMMARY

Embodiments herein disclose use of space vector pulse width modulation techniques in a single phase motor connected to a single phase drive system.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a diagram which depicts the arrangement used for space vector pulse width modulation/sine triangle PWM in single phase motors, as disclosed in the embodiments herein;

FIG. 2a illustrates a diagram which depicts the spatial orientation of the motor winding as disclosed in the embodiments herein.

FIG. 2b illustrates a diagram which depicts the spatial orientation of the MMF for various states of lower PWM switches as disclosed in the embodiments herein;

FIG. 3a illustrates a diagram which depicts the trajectory of uniform spatial RMF as disclosed in the embodiments herein; and

FIG. 3b illustrates a diagram which depicts the switching sequence in first sector as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

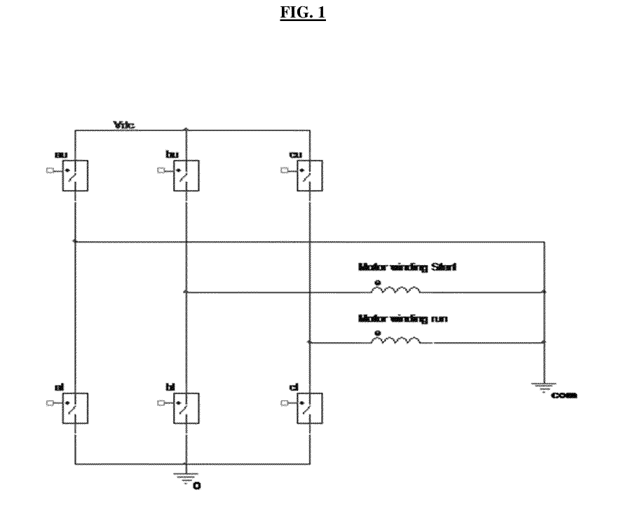

The embodiments herein disclose use of pulse width modulation techniques in a single phase motor connected to a single phase drive system. Referring now to the drawings, and more particularly to FIGS. 1 through 3b, where similar reference characters denote corresponding features consistently throughout the figures, there are shown embodiments.

FIG. 1 illustrates a diagram which depicts the arrangement used for space vector pulse width modulation in single phase motors, as disclosed in the embodiments herein. Space vector modulation is an algorithm for the control of pulse width modulation. Space vector modulation is used for the creation of alternating current (AC) waveforms, most commonly to drive 3 phase AC powered motors at varying speeds from DC using multiple class-D amplifiers.

FIG. 1 indicates the three armed arrangement used for implementing SVPWM. The arms are indicated by a, b, and c respectively. Further, the lower switch in a arm is a1 and b arm is b1 and c arm is c1. The upper switch in a arm is au and b arm is bu and c arm is cu. Further, the motor start winding is connected to b arm. The motor run winding is connected to c arm and common point is connected to a arm.

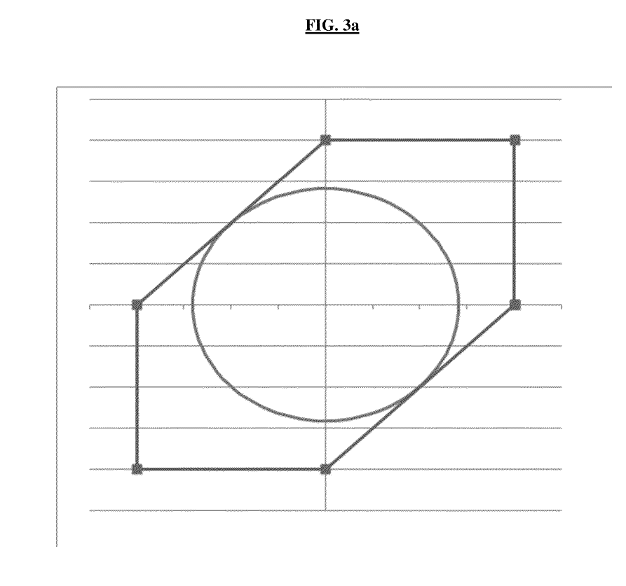

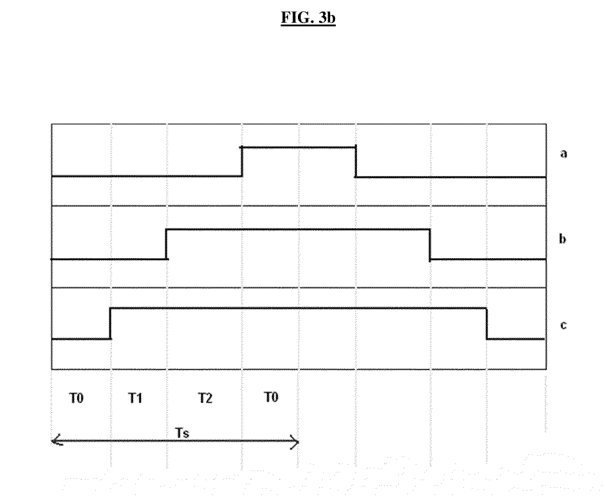

The set of switches are connected in a complimentary manner. This enables the necessary PWM voltage across the windings of a single phase inductor. The signal, as depicted in FIG. 3b is applied to each of the arms in a complimentary manner.

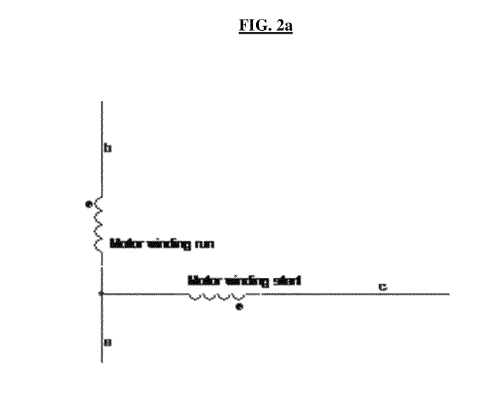

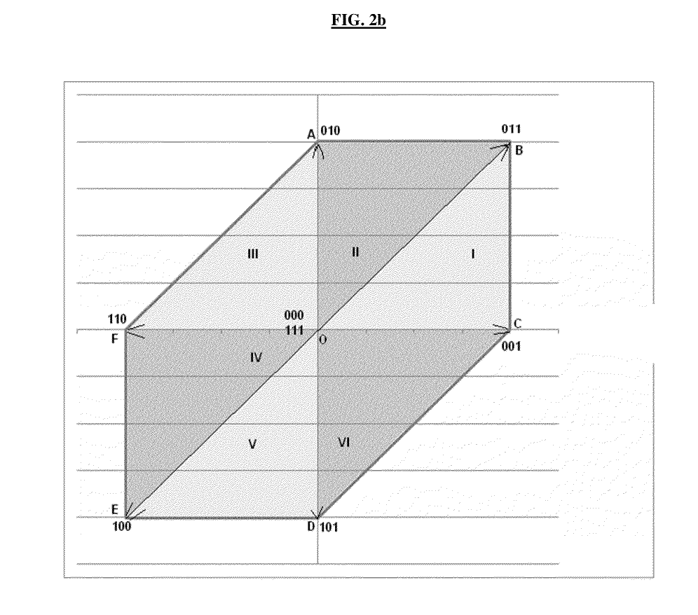

FIG. 2a illustrates a diagram which depicts the spatial orientation of the motor winding as disclosed in the embodiments herein. From FIG. 2a, it can be seen that there is a space angle of 90 degrees between the spatial distributions of motor windings. Once current is supplied at 90 degrees phase angle between the spatial distributions of motor windings, a revolving magnetic field in motor space is obtained. The revolving magnetic field has a sinusoidal spatial and time distribution.

FIG. 2b illustrates a diagram which depicts the spatial orientation of the MMF for various states of lower PWM switches as disclosed in the embodiments herein. From FIG. 2b, the spatial MMF (Magneto-motive force) can be seen when DC current is passed through the windings. The positive direction of x axis is assumed to be along motor winding start in a to c terminal direction. Further, from FIG. 2b, the y axis is assumed to be along motor winding run in a to b direction. The corners of the polygon are notated with a binary number. Further, the binary number indicates the state of terminal a, b, and c shown in FIG. 1 respectively. From FIG. 1, it is indicated that there is a voltage equivalent to DC bus voltage available at that terminal.

For example, if terminal state is 011, a terminal has zero voltage, b terminal has VDC, and C terminal has VDC. This will cause an ultimate orientation of spatial MMF in the direction OB. Similarly, spatial orientations along OC, OD, OE, OF, and OA are caused by states 001, 101, 110 and 010. Further, state 000 and state 111 are called zero vectors as they do not produce any MMF. The six non-zero vectors divides the motor space into six sectors named I, II, III, IV, V and VI. Further, to obtain any vector in the space of sector I, vectors OB and OC are switched. While moving from one vector to another, it should be ensured that travel through a zero vector must have minimum number of switch transitions.

For example, for moving in sector I, states 000, 001, 011, 111, 011, 001, 000 sequences are switched. The space vector's amplitude may be modulated by changing the duration of zero vector. Further, the polygon ABCDEFA shows the locus of the MMF when zero vectors are not used.

FIG. 3a illustrates a diagram which depicts the maximum trajectory of uniform spatial RMF (Revolving magnetic force) as disclosed in the embodiments herein. FIG. 3a shows the maximum trajectory of uniform revolving magnetic field in the motor space. Beyond this, the revolving magnetic field becomes distorted as zero vectors are extended to the minimum when the RMF locus touches the polygon.

FIG. 3b illustrates a diagram which depicts the switching sequence in first sector as disclosed in the embodiments herein. Initially, it should be considered that a RMF revolution is required in the direction CBAFEDC in the motor space. Consider a to be space angle from the first vector in a sector. For example, the first vector in sector I is OC, second vector in sector I is OB, first vector in sector II is OB and so on.

FIG. 3b shows the switching sequence in the first sector. α is the space angle from the first vector in a sector. Initially, a zero vector (000) is enabled for T0, which is given by (Ts−(T1+T2))/2. Further, a first vector (001) that is enabled for duration T1. Once the first vector (001) of this particular sector is introduced for calculated time T1, second vector (011) is introduced for calculated time T2. Further, zero vector (111) is introduced again for the time T0 to complete a cycle. The next cycle is anti-symmetric and the cycle starts with zero vector (111) and switches the second vector first and then the first vector. The zero vector to end would be (000). Further, the first and the second vectors for time duration T1 and T2 can be switched to get a space vector of magnitude |Vs| by the following computation:

### Sector I and IV

T1=(|Vs|/Vdc)*Ts*(cos α−sin α)

T2=(|Vs|/Vdc)*Ts*sin α

### Sector II and V

T1=(|Vs|/Vdc)*(Ts/√2)*(cos α−sin α)

T2=(|Vs|/Vdc)*Ts*√2*sin α

### Sector III and VI

T1=(|Vs|/Vdc)*Ts*cos α

T2=(|Vs|/Vdc)*Ts*sin α

In all sequences, T0(Ts−T1−T2)/2

### Where,

Ts is the switching time period
Vdc is the DC bus voltage.

For enhancing the trajectory of voltage space vector, when the requirement for Vs is greater than Vdc/√2, Vs as disclosed herein is limited such that the operating range is limited to the polygon shape, as depicted in FIG. 3. To limit the vector, for example in sector III and VI, the value of Vs is re-computed such that if (T1+T2)/Ts exceeds 1, the new Vs is re-computed as Vdc/(cos α+sin α) and applied in their respective equations. In another example, to limit it in sector II and V, for all values of a which gives (T1+T2)/Ts greater than 1, Vs is recomputed as Vdc*√2/(cos α+sin α). In yet another example, to limit it in sector I and IV, Vs is recomputed as Vdc/cos α for all values of α that causes (T1+T2)/Ts greater than 1 for a particular definition of Vs. The definitions of Vs up to Vdc*√2 provide unique switching patterns that will enhance the space vector applied to the motor.

Embodiments disclosed above enable enlargement of the operating voltage in a single phase motor connected to a single phase drive system using SVPWM. Embodiments disclosed herein enable a 15% increment in maximum voltage compared to conventional PWM; hence space vector enables efficient use of DC voltage. Further, embodiments disclosed herein provide excellent output performance, optimized efficiency and high reliability compared to similar inverters with sine triangle PWM.

The embodiment disclosed herein discloses use of pulse width modulation techniques in a single phase motor connected to a single phase drive system. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A method for enabling operation of a single phase induction motor, the method comprising
applying space vector Pulse Width Modulation (PWM) to the single phase induction motor;
determining pulse width using location of the space vector associated with space vector PWM; and
enhancing voltage levels of the single phase induction motor for a particular DC bus voltage using the determined pulse width and the location of the space vector.

2. The method, as claimed in claim 1, wherein a space angle of 90 degrees is present between windings of the single phase induction motor.

3. The method, as claimed in claim 2, wherein said method further comprises dividing space between said windings into a plurality of sectors by a plurality of non-zero vectors.

4. The method, as claimed in claim 1, wherein magnitude of a voltage space vector (Vs) achieves a maximum value of Vdc√2.

5. The method, as claimed in claim 4, wherein said Vs is obtained by switching a first vector from said plurality of vectors for time duration (T1) and a second vector from said plurality of vectors for time duration (T2).

6. The method, as claimed in claim 5, wherein said Vs is obtained for sectors I and IV in said plurality of sectors using
T1=(|Vs|/Vdc)*Ts*(cos α−sin α)
T2=(|Vs|/Vdc)*Ts*sin α
Where Ts is switching time period
Vdc is said DC bus voltage.

7. The method, as claimed in claim 5, wherein said Vs is obtained for sectors II and V in said plurality of sectors using
T1=(|Vs|/Vdc)*(Ts/√2)*(cos α−sin α)
T2=(|Vs|/Vdc)*Ts*√2*sin α
Where Ts is the switching time period
Vdc is said DC bus voltage.

8. The method, as claimed in claim 5, wherein said Vs is obtained for sectors III and VI in said plurality of sectors using
T1=(|Vs|/Vdc)*Ts*cos α
T2=(|Vs|/Vdc)*Ts*sin α
Where Ts is the switching time period
Vdc is said DC bus voltage.

9. The method, as claimed in claim 6, wherein said method further comprises limiting said space vector in said sectors I and IV for all values of α to obtain
(T1+T2)/Ts greater than 1; and
recomputing said Vs as Vdc/cos α.

10. The method, as claimed in claim 7, wherein said method further comprises limiting said space vector in said sectors II and V for all values of α to obtain
(T1+T2)/Ts greater than 1; and
recomputing said Vs as Vdc*√2/(cos α+sin α).

11. The method, as claimed in claim 8, wherein said method further comprises limiting said space vector in said sectors III and VI for all values of α to obtain
(T1+T2)/Ts greater than 1; and
recomputing said Vs as Vdc/(cos α+sin α).

12. A single phase induction motor configured for
applying space vector Pulse Width Modulation (PWM);
determining pulse width using location of the space vector associated with space vector PWM; and
enhancing voltage levels for a particular DC bus voltage using the determined pulse width and the location of the space vector.

13. The motor, as claimed in claim 12, wherein a space angle of 90 degrees is present between windings of the single phase induction motor.

14. The motor, as claimed in claim 12, wherein said space between said windings is divided into a plurality of sectors by a plurality of non-zero vectors.

15. The motor, as claimed in claim 12, wherein the motor is configured for enabling magnitude of a voltage space vector (Vs) to achieve a maximum value of Vdc√2.

16. The motor, as claimed in claim 15, wherein said Vs is obtained by switching a first vector from said plurality of vectors for time duration (T1) and a second vector from said plurality of vectors for time duration (T2).

17. The motor, as claimed in claim 16, wherein said Vs is obtained for sectors I and IV in said plurality of sectors using
T1=(|Vs|/Vdc)*Ts*(cos α−sin α)
T2=(|Vs|/Vdc)*Ts*sin α
Where Ts is the switching time period
Vdc is said DC bus voltage.

18. The motor, as claimed in claim 16, wherein said Vs is obtained for sectors II and V in said plurality of sectors using
T1=(|Vs|/Vdc)*(Ts/√2)*(cos α−sin α)
T2=(|Vs|/Vdc)*Ts*√2*sin α
Where Ts is the switching time period
Vdc is said DC bus voltage.

19. The motor, as claimed in claim 16, wherein said Vs is obtained for sectors III and VI in said plurality of sectors using
T1=(|Vs|/Vdc)*Ts*cos α
T2=(|Vs|/Vdc)*Ts*sin α
Where Ts is the switching time period
Vdc is said DC bus voltage.

20. The motor, as claimed in claim 17, wherein said motor is further configured to limit said space vector in said sectors I and IV for all values of α to obtain
(T1+T2)/Ts greater than 1; and
recomputing said Vs as Vdc/cos α.

21. The motor, as claimed in claim 18, wherein said motor is further configured to limit said space vector in said sectors II and V for all values of α to obtain
(T1+T2)/Ts greater than 1; and
recomputing said Vs as Vdc*√2/(cos α+sin α).

22. The motor, as claimed in claim 19, wherein said motor is further configured to limit said space vector in said sectors III and VI for all values of α to obtain
(T1+T2)/Ts greater than 1; and
recomputing said Vs as Vdc/(cos α+sin α).
